(19) United States
(12) Patent Application Publication
(10) Pub. No.: US 2024/0340150 A1
(43) Pub. Date: Oct. 10, 2024

(54) TECHNOLOGIES FOR BEAM CONFIGURATION AND INDICATION FOR LOWER-LAYER TRIGGERED MOBILITY

(71) Applicant: Apple Inc., Cupertino, CA (US)

(72) Inventors: Hong He, San Jose, CA (US); Chunxuan Ye, San Diego, CA (US); Dawei Zhang, Saratoga, CA (US); Haitong Sun, Saratoga, CA (US); Jie Cui, San Jose, CA (US); Oghenekome Oteri, San Diego, CA (US); Wei Zeng, Saratoga, CA (US)

(73) Assignee: Apple Inc., Cupertino, CA (US)

(21) Appl. No.: 18/595,264

(22) Filed: Mar. 4, 2024

Related U.S. Application Data
(60) Provisional application No. 63/458,041, filed on Apr. 7, 2023.

(51) Int. Cl. H04L 5/00; H04W 72/044

(52) U.S. Cl. CPC H04L 5/0091; H04W 72/046

(57) ABSTRACT

The present application relates to devices and components including apparatus, systems, and methods for beam configuration and indication for lower-layer triggered mobility in wireless networks.

### RELATED APPLICATIONS

This application claims the benefit of U.S. Provisional Patent Application No. 63/458,041, filed Apr. 7, 2023, which is hereby incorporated by reference in its entirety.

### TECHNICAL FIELD

This application relates generally to wireless communication networks and, in particular, to technologies for beam configuration and indication for lower-layer triggered mobility (LTM) in said networks.

### BACKGROUND

Third Generation Partnership Project (3GPP) Technical Specifications (TSs) provide details of radio interface protocols to facilitate communication over wireless networks. These TSs define how and when a user equipment (UE) can transition from a source cell to a target cell to improve coverage.

### BRIEF DESCRIPTION OF THE DRAWINGS

FIG. 1 illustrates a network environment in accordance with some embodiments.

FIG. 2 illustrates a serving cell configuration in accordance with some embodiments.

FIG. 3 illustrates cell configurations in accordance with some embodiments.

FIG. 4 illustrates cell and common pool configurations in accordance with some embodiments.

FIG. 5 illustrates a signaling procedure in accordance with some embodiments.

FIG. 6 illustrates another signaling procedure in accordance with some embodiments.

FIG. 7 illustrates a media access control (MAC) control element (CE) in accordance with some embodiments.

FIG. 8 illustrates another MAC CE in accordance with some embodiments.

FIG. 9 illustrates MAC CEs in accordance with some embodiments.

FIG. 10 illustrates a physical downlink control channel (PDCCH) order downlink control information (DCI) in accordance with some embodiments.

FIG. 11 illustrates a network environment in accordance with some embodiments.

FIG. 12 illustrates a signaling diagram in accordance with some embodiments.

FIG. 13 illustrates another signaling diagram in accordance with some embodiments.

FIG. 14 illustrates an operational flow/algorithmic structure in accordance with some embodiments.

FIG. 15 illustrates another operational flow/algorithmic structure in accordance with some embodiments.

FIG. 16 illustrates a user equipment in accordance with some embodiments.

FIG. 17 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The terms “multi,” “multiple,” “plurality,” and the like as used herein refer to more than one item, instance, or event.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

New mobile services that require low-latency and high-reliability performance (for example, ultra-reliable low-latency communications (URLLC)) are emerging. While 3GPP 5th generation (5G) standards were designed to address these services from the beginning, evolution of 5G New Radio (NR) and future 6th generation (6G) radio access networks (RANs) need to continuously enhance the mobility robustness performance for these challenging scenarios.

Layer 1 (L1) enhancements for inter-cell beam management, including L1 measurement and reporting, and beam indication are items of study to facilitate mobility improvement. The phrase “beam indication,” as used in beam management concepts, represents signaling in which a user equipment (UE) obtains a new quasi-co-location (QCL) indication for reception of downlink (DL) signals such as, for example, physical downlink control channel (PDCCH) or physical downlink shared channel (PDSCH) transmissions. Beam indication may be relevant to LTM operations in which measurements and cell-switch commands (CSCs) are performed at lower-layers of a communication protocol, e.g., L1 or Layer 2 (L2). In the context of LTM, once a new QCL indication takes effect, for example, after a beam application time, the UE would receive DL transmissions from a new transmit-receive point (TRP).

A QCL relationship between a source and a target may be defined by a transmission configuration indicator (TCI) state. The source and target may be reference signals such as, for example, a synchronization signal block (SSB), a channel state information-reference signal (CSI-RS) (for beam management or channel quality indicator (CQI) measurement), a sounding reference signal (SRS), or a demodulation reference signal (DMRS). Channel properties (for example, spatial, time, or frequency domain properties) determined for the source may be inferred with respect to the target. Different QCL types indicate different channel properties may be inferred. For example, QCL Type A corresponds to Doppler shift, Doppler Spread, average delay, and delay spread; QCL Type B corresponds to Doppler shift and Doppler spread; QCL Type C corresponds to Doppler shift and average delay; and QCL Type D corresponds to a spatial Rx parameter.

Various embodiments of the present disclosure describe the indication of beam information for candidate cells in a manner that reduces cell-switching latency. Some embodiments describe how to configure TCI-state information associated with candidate cells. These embodiments provide a design that considers the impact on a UE's power consumption and complexity caused by parsing radio resource control (RRC) configurations associated with candidate cells. This may be important given that a network environment may have a large number of candidate cells, and processing RRC configuration information elements (IEs) associated with each candidate cell may be computationally intensive. Further embodiments also describe how to efficiently signal beam-indication information to derive TCI states for target candidate cell(s) to facilitate an LTM procedure. These embodiments may take into account a situation in which a serving distributed unit (DU) may not know the measurement reference signal (RS) configuration and TCI-state configuration of cells served by another DU, which may be provided by another infrastructure vendor.

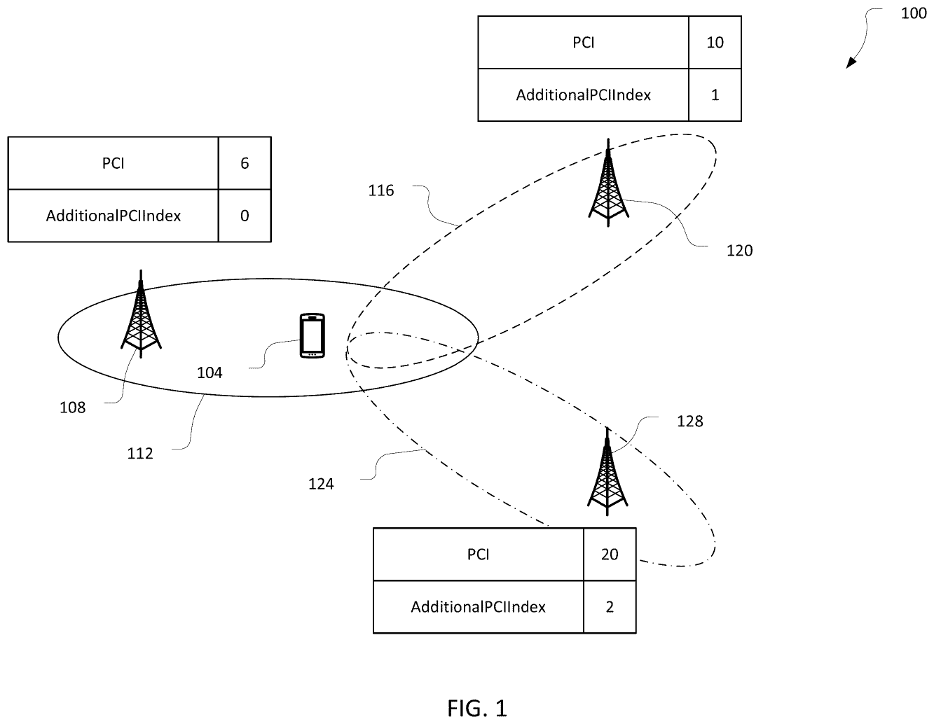

FIG. 1 illustrates a network environment 100 in accordance with some embodiments. The network environment 100 may include a UE 104 communicatively coupled with a base station 108 that provides a serving cell 112. The serving cell 112 may provide an air interface compatible with 3GPP TSs, such as those that define 5G NR or later system standards. Operations described herein with respect to the serving cell 112 may be performed by the base station 108, and vice versa. Depending on the technology, the base station 108 may be referred to as an eNB, gNB, an ng-NB, etc. The base station 108 may provide the UE 104 access to other networks, for example, a core network, a data network, etc.

The network environment 100 may further include two candidate cells, candidate cell 116 provided by base station 120 and candidate cell 124 provided by base station 128. The base stations 120 and 128 may provide an access technology similar to that described above with respect to base station 108.

The base stations 108, 120, and 128 may be DUs provided by one or more vendors. The serving cell 112 and candidate cells 116 and 124 may each be associated with a separate physical cell identifier (PCI). For example, serving cell 112 may have a PCI of 6, candidate cell 116 may have a PCI of 10, and candidate cell 124 may have a PCI of 20.

To facilitate LTM operation, the serving cell 112 may configure the UE 104 with TCI-state information corresponding to the candidate cells 116 and 124. This may be done in one or more of the following options.

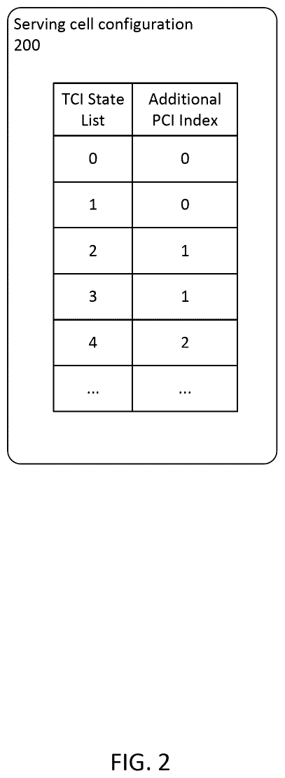

In a first option, TCI states associated with the candidate cells 116 and 124 may be provided under the serving cell 112 through dedicated RRC signaling. For example, the serving cell 112 may transmit an RRC message to configure a serving cell configuration 200 as shown in FIG. 2 in accordance with some embodiments. To facilitate this operation, each cell may be configured with an additional PCI index (additionalPCIIndex) value. The additionalPCIIndex value may be a logical identifier that is different from, but associated with, the PCI. For example, the serving cell 112 may be associated with an additionalPCIIndex value of 0, the candidate cell 116 may be associated with an additionalPCIIndex value of 1, and the candidate cell 116 may be associated with an additionalPCIIndex value of 2. The network, e.g., serving cell 112, may provide an RRC configuration, e.g., an additionalPCIIndex IE, to the UE 104 to provide a mapping between additionalPCIIndex values and PCI values of the candidate cells. This RRC configuration may be provided separately from the serving cell configuration 200.

The serving cell configuration 200 may associate individual TCI states from a TCI-state list with an additionalPCIIndex value. In particular, TCI states 0 and 1 may be associated with additionalPCIIndex value 0 corresponding to PCI 6 of serving cell 112, TCI states 2 and 3 may be associated with additionalPCIIndex value 1 corresponding to PCI 10 of candidate cell 116, and TCI state 4 may be associated with additionalPCIIndex value 2 corresponding to PCI 20 of candidate cell 124.

Using the additionalPCIIndex values as an index of the configured PCIs as described may save a significant amount of signaling resources for providing a TCI-state list configuration. Assuming the UE 104 is configured with eight PCIs, three bits may be sufficient for the additionalPCIIndex value to indicate each PCI. If the UE 104 were to signal the PCI directly, each PCI ID may consume 12 bits, thereby requiring 12*8=96 bits of signaling overhead.

In some embodiments, an additionalPCIIndex IE may be included in a TCI-state configuration to indicate the PCI of an associated candidate cell.

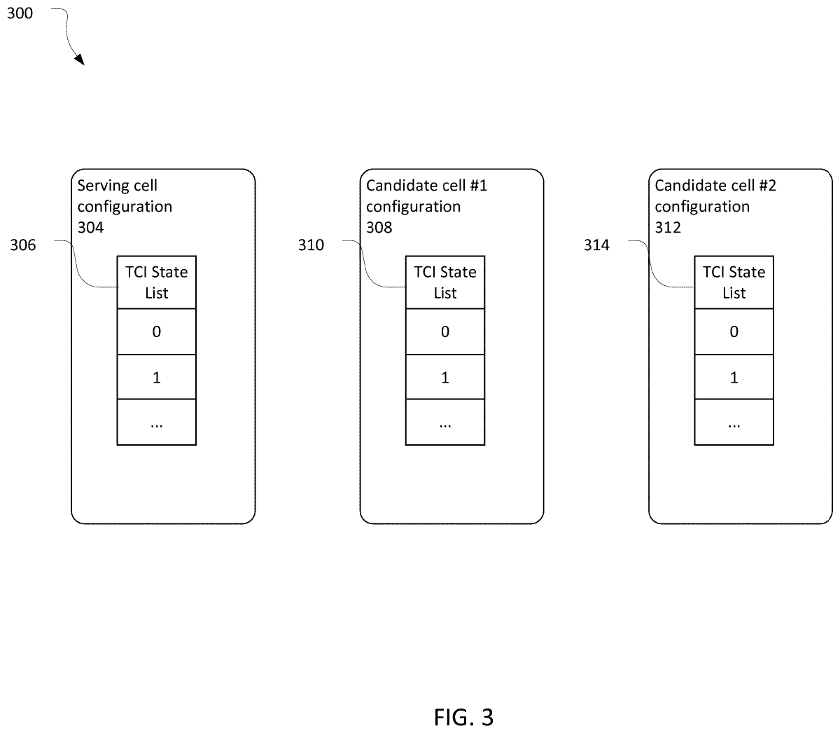

In a second option, a TCI-state list associated with each candidate cell may be provided under the respective candidate cell as part of a cell group (CG) configuration. This may be done in accordance with one example by the serving cell 112 providing the UE 104 with configurations 300 of FIG. 3 in accordance with some embodiments.

The configurations 300 may include a serving cell configuration 304 corresponding to serving cell 112, a candidate cell #1 configuration 308 corresponding to candidate cell 116, and a candidate cell #2 configuration 312 corresponding to candidate cell 124. Each configuration may provide a respective TCI-state list. The serving cell configuration 304 may include a TCI-state list 306 that includes TCI states for the serving cell 112. The candidate cell #1 configuration 308 may include a TCI-state list 310 that includes TCI states for the candidate cell 116. And the candidate cell #2 configuration 312 may include a TCI-state list 314 that includes TCI states for the candidate cell 124.

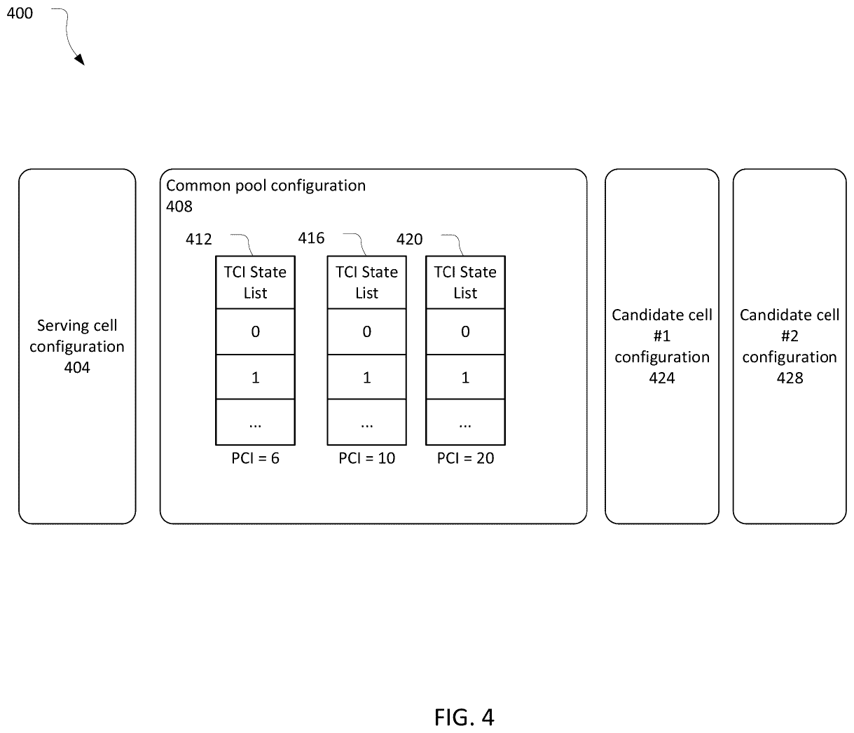

In a third option, TCI-state lists associated with the candidate cells may be provided in a common pool configuration that is independent of serving/candidate cell configurations. FIG. 4 illustrates configurations 400 that may be used for the third option in accordance with some embodiments.

The configurations 400 may include a serving cell configuration 404, a common pool configuration 408, a candidate cell #1 configuration 424, and a candidate cell #2 configuration 428.

The cell configurations-serving cell configuration 404, candidate cell #1 configuration 424, and candidate cell #2 configuration 428—may include information other than the TCI state lists that may be used to configure (e.g., add or modify) the UE 104 with the different cells. For example, this other information may include bandwidth part (BWP) information, time division duplex (TDD) information, measurement configurations, etc. In some embodiments, the cell configurations may be similar to serving cell configuration as defined in 3GPP TS 38.331 v17.4.0 (2023-03).

The common pool configuration 408 may include a plurality of TCI-state lists that may correspond to a respective plurality of PCIs (cells). For example, the common pool configuration 408 may include TCI-state list 412 for PCI 6 (serving cell 112), TCI-state list 416 for PCI 10 (candidate cell 116), and TCI-state list 420 for PCI 20 (candidate cell 124).

Providing the common pool configuration 408 may allow the UE 104 to avoid parsing the full configurations of the candidate cells before receiving a CSC. Rather, the UE 104 only needs to parse the common pool configuration 408 to determine the various TCI states. If the UE 104 receives a CSC that instructs a switch to candidate cell 116, for example, the UE 104 may thereafter parse the candidate cell #1 configuration 424 but may not need to parse other configurations such as, for example, candidate cell #2 configuration 428. This may reduce power consumption at the UE 104.

TCI states of a candidate cell may be activated based on measurement reports received by the network. Activation of TCI states associated with candidate cells may be performed according to a first option in which the serving base station 108 selects the TCI states for activation or according to a second option in which the serving base station 108 provides an indication of target RSs to the UE 104, which are then mapped to the TCI states by the UE 104.

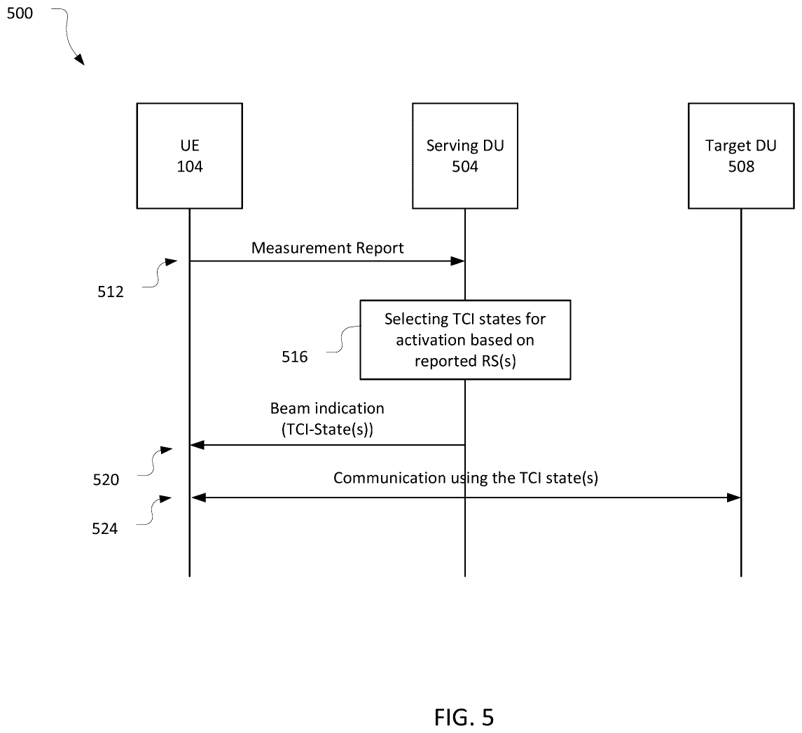

FIG. 5 illustrates a signaling procedure 500 for TCI-state activation based on the first option in accordance with some embodiments. The signaling procedure 500 may include signals between, and operations performed by, the UE 104, a serving DU 504, and a target DU 508. The serving DU 504 may correspond to the base station 108 of FIG. 1 and the target DU 508 may correspond to the base station 120 or 128 of FIG. 1.

The signaling procedure 500 may include, at 512, the UE 104 sending a measurement report to the serving DU. The measurement report 512 may based on measurements of various RSs that are configured for measurement. The RSs may include SSBs or channel state information-reference signals (CSI-RSs) transmitted in various cells including both serving cells and candidate cells. In some embodiments, the measurement report 512 may include an indication of desirable RSs, e.g., RSs that meet a predetermined criteria for supporting communications. The predetermined criteria may be, for example, that a L1-reference signal receive power (RSRP) measurement of the RS is above a predetermined threshold.

Upon receiving the measurement report, which may constitute one consolidated report or a plurality of individual reports, the serving DU 504 may select TCI states for activation based on the reported RSs at 516.

The signaling procedure 500 may then include the serving DU 504 transmitting a beam-indication message at 520. The beam-indication message may indicate N TCI states that are to be activated, where Nis an integer greater than zero. The N TCI states may be associated with at least one candidate cell.

The signaling procedure 500 may further include, at 524, the UE 104 and the target DU 508 communicating using one or more of the N activated TCI states. Communicating may include, for example, the UE 104 receiving DL signals based on a DL TCI state associated with the target DU.

The signaling procedure 500 may be used for TCI-state activation in the event the serving DU 504 has knowledge of the TCI-state lists of the candidate cells (e.g., target DU 508). In the event the serving DU 504 does not have knowledge of the TCI-state lists, the second option may be used. The second option may use two-step signaling to indicate the beam information for candidate cells.

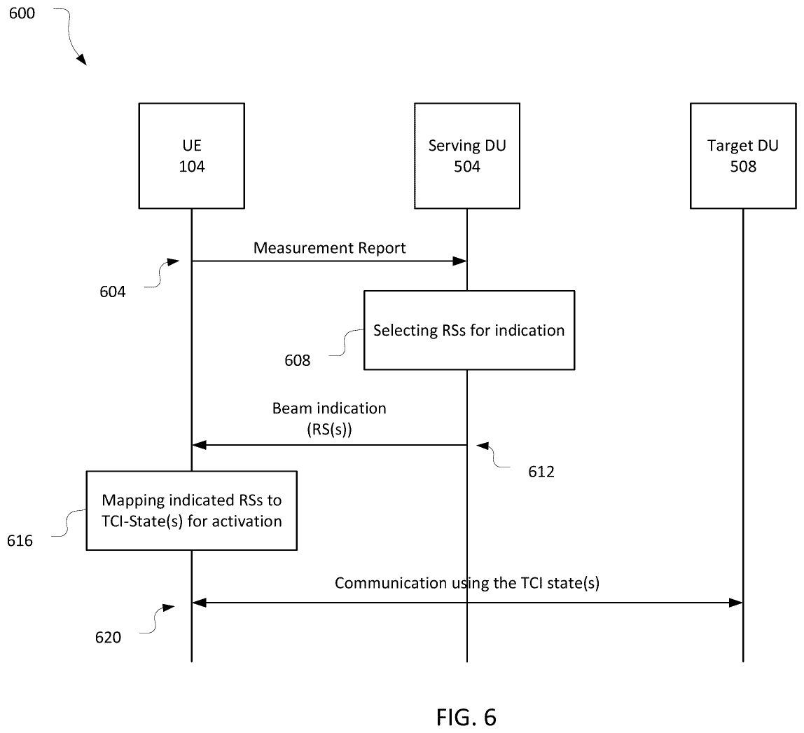

FIG. 6 illustrates a signaling procedure 600 for TCI activation based on the second option in accordance with some embodiments. The signaling procedure 600 may include signals between, and operations performed by, the UE 104, the serving DU 504, and the target DU 508.

The signaling procedure 600 may include, at 604, the UE 104 sending a measurement report to the serving DU. The measurement report at 604 may be similar to the measurement report described above with respect to FIG. 5.

Upon receiving the measurement report, the serving DU 504 may select RSs for indication from the reported RSs at 608.

The signaling procedure 600 may then include the serving DU 504 transmitting a beam-indication message at 612. The beam-indication message may provide RS IDs or indexes to indicate N RSs that are selected from the measurement report. The RSS may be SSB or CSI-RSs of the candidate cells, which may be configured by RRC signaling.

The signaling procedure 600 may further include, at 616, the UE 104 mapping indicated RSs to TCI states for activation. The UE may derive the TCI states associated with the indicated RSs based on the TCI-state lists provided earlier for a corresponding candidate cell (for example, by configurations 300 or 400).

The signaling procedure 600 may further include, at 620, the UE 104 and the target DU 508 communicating using the activated TCI states. Communicating may include, for example, the UE 104 receiving DL signals based on a DL TCI state associated with the target DU or transmitting UL signals based on a UL TCI state associated with the target DU.

The signaling procedure 600 may be used for TCI-state activation in the event the serving DU 504 has no (or incomplete) knowledge of the TCI state lists of the candidate cells (e.g., target DU 508), but the UE 104 has been configured with this information. It may be noted that even if the serving cell 112 configures the UE 104 with TCI-state lists of the candidate cells (e.g., by providing configurations 200 or 300), the serving base station 108 may still not have knowledge of the configured information directly. Thus, in this case, the base station 108 may rely on the UE 104 to provide that associations based on that configured information.

Various signaling approaches may be used to provide the beam information (e.g., RS IDs or indexes) in the beam-indication message of FIG. 6. This may be done according to one or more of the following three aspects.

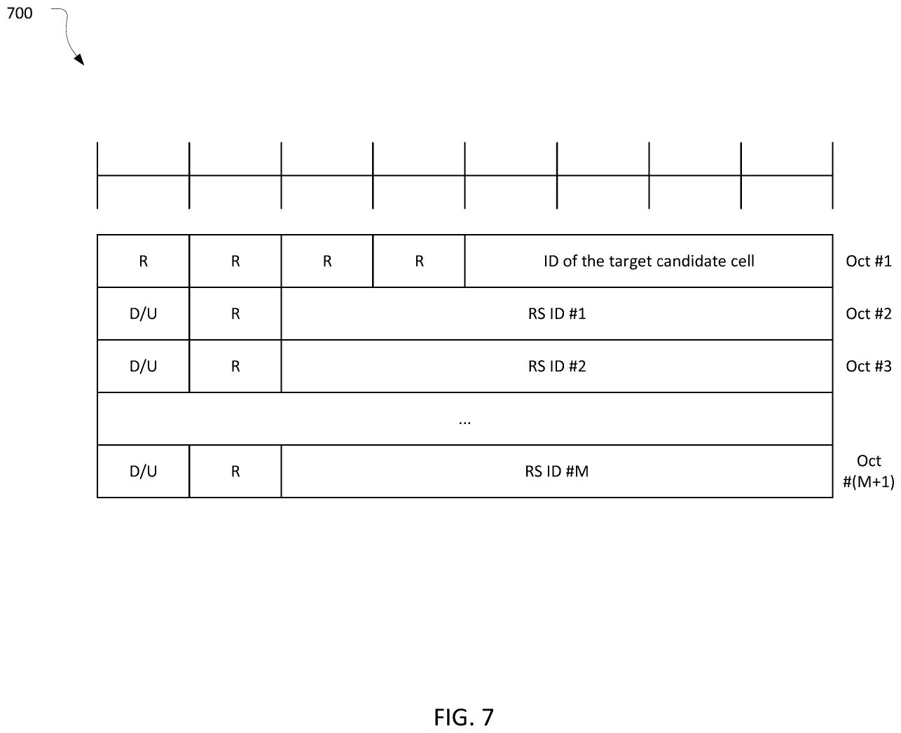

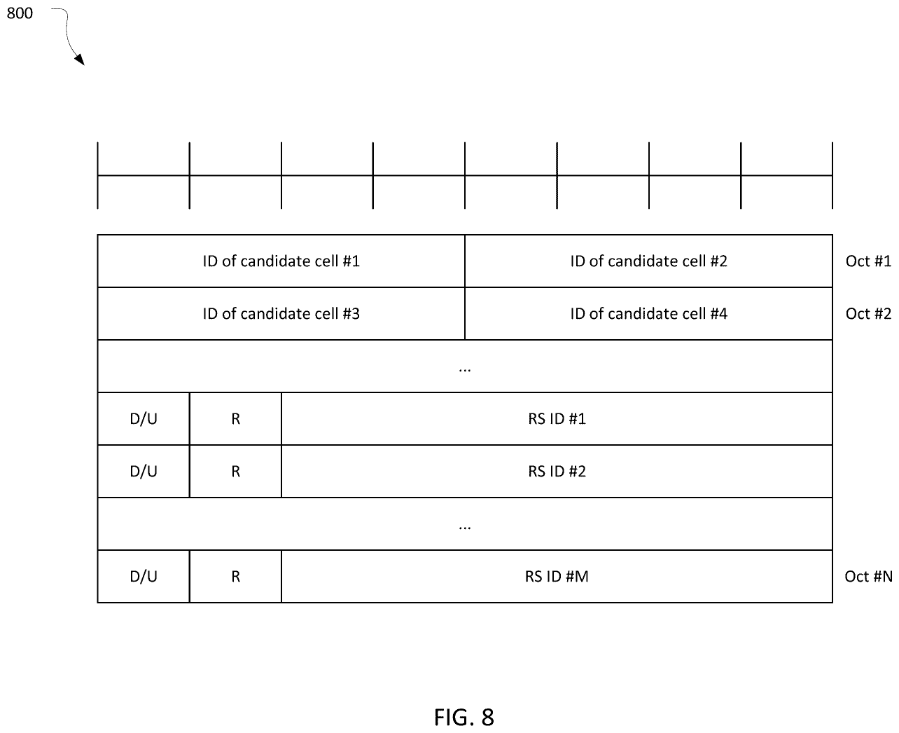

In a first aspect, the TCI state activation/deactivation MAC CE may be enhanced to explicitly indicate RS IDs. A MAC CE that indicates RS IDs for TCI state activation/deactivation may be identified by a new dedicated MAC subheader with extended logical channel identifier (eLCID). The MAC CE to indicate RS IDs of the first aspect may be generated according to one or more of the following two options as illustrated in FIGS. 7 and 8.

FIG. 7 illustrates a MAC CE 700 that may be used to indicate RS IDs for TCI state activation/deactivated based on the first option in accordance with some embodiments. The MAC CE 700 may indicate one or more RS IDs for a single candidate cell.

The MAC CE 700 may include, in a first octet, an ID of the target candidate cell. In each of the following octets, an RS ID is provided. The RS IDs are shown as six bits, which may allow for the indication of one of up to sixty-four TCI states that may typically be configured. As shown, the MAC CE 700 may indicate M RS IDs. An octet may also include a “D/U” bit to indicate whether the RS ID in the same octet is to be used to derive a joint/downlink or uplink TCI state. If the D/U bit is set to a first value, e.g., ‘0,’ the associated TCI state may be a joint TCI state (e.g., used for both UL and DL) or a DL TCI state. If the D/U bit is set to a second value, e.g., ‘1,’ the associated TCI state may be an UL TCI state. If an UL TCI state is activated, then it may be paired with an activated joint/DL TCI state.

FIG. 8 illustrates a MAC CE 800 that may be used to indicate RS IDs for TCI state activation/deactivated based on the second option in accordance with some embodiments. The MAC CE 800 may indicate one or more RS IDs for a plurality of candidate cells.

The first octets of the MAC CE 800 may provide IDs of the plurality of candidate cells. As shown, the first octet may include IDs of candidate cells #1 and #2, while the second octet may include IDs of candidate cells #3 and 4.

Following the candidate cell IDs, the MAC CE 800 may include the RS IDs. And, similar to MAC CE 700, each octet may also include a “D/U” bit to indicate whether the RS ID in the same octet is to be used to derive a joint/downlink or uplink TCI state.

Each of the listed candidate cells may have one or two of the indicated RS IDs to derive DL and UL TCI states for potential LTM operation. The associations between an RS ID and TCI state(s) may be based on order of presentation. For example, the ID of candidate cell #1 may be associated with RS ID #1 (if RS ID #1 is indicated as a joint/DL TCI state and RS ID #2 is indicated as a joint/DL state) or may be associated with both RS ID #1 and #2 (if RS ID #1 is indicated as a joint/DL TCI state and RS ID #2 is indicated as an UL TCI state); the ID of candidate cell #2 may be associated with the next one or two TCI states, etc.

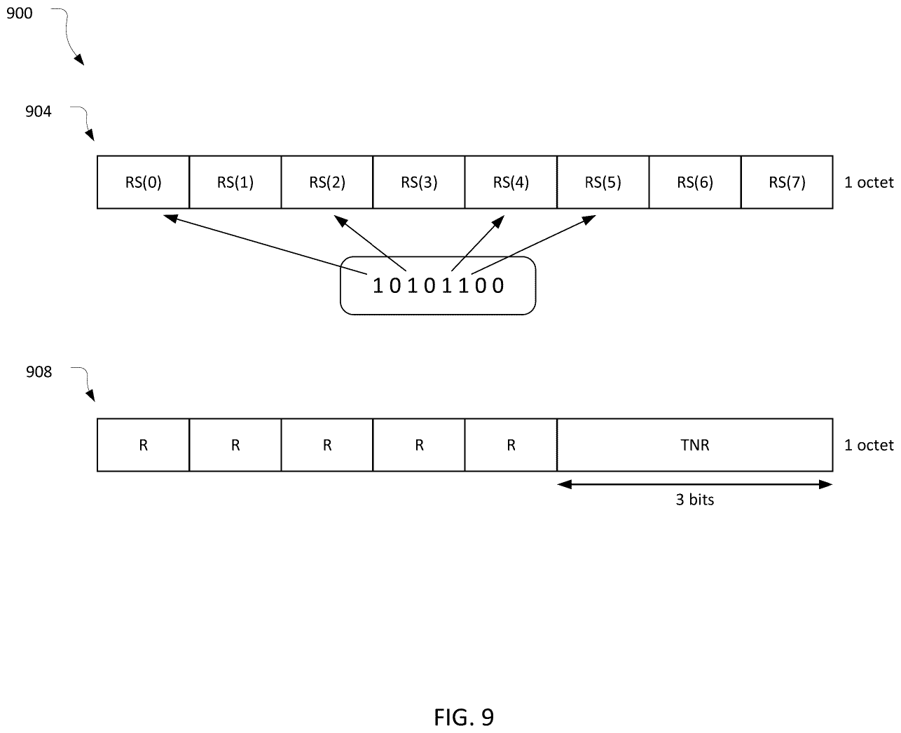

A second aspect of providing beam information in the beam-indication message of FIG. 5 may be based on the UE-reported RS IDs in the measurement reports transmitted at 512 and 604. According to this aspect, a new MAC CE may be introduced to signal indexes that correspond to the RS(s) reported by the UE 104 in the most recent measurement report is to be used for TCI-state mapping. This may be done based on one or more of the following two options as illustrated in MAC CEs 900 of FIG. 9 in accordance with some embodiments.

The MAC CEs 900 may include a MAC CE 904 that may be used in a first option in which bitmap-based signaling is used with respect to the UE-reported RS IDs. The total number of RSs reported by the UE 104 for each measurement report, denoted as ‘N,’ may be configured by RRC signaling. The MAC CE 904 may include RS (i) fields. Assuming eight RSs are reported by the UE 104, e.g., N=8, the MAC CE 904 may include eight fields, RS(0) RS (7). The RS (i) fields may be arranged such that increasing values of i are associated with decreasing L1-RSRP values. For example, RS(0) is associated with the RS having the largest measured value of L1-RSRP, RS (1) is associated with the RS having the second largest measured value of L1-RSRP, etc. A first bit value, e.g., ‘1,’ may signal that the corresponding RS ID (and associated RS) is indicated for a TCI-state activation basis (e.g., for activation of a TCI state that corresponds to the RS), while a second bit value, e.g., ‘0,’ may signal that the related RS is not indicated for TCI-state activation basis. Thus, a value of 10101100 may signal that the RSs reported with the largest, third largest, fifth largest, and sixth largest L1-RSRPs are indicated. Thereafter, the UE 104 may activate TCI states associated with the indicated RSs.

The MAC CEs 900 may also include a MAC CE 908 that may be used in a second option that relies on a total number of UE-reported RS IDs. The second option may include a first step in which the RS IDs reported by the UE 104 in the measurement report are numbered continuously in order of decreasing L1-RSRP values. The MAC CE 908 may then include a total number of RS(s) (TNR) field that may be used to signal the total number of contiguous RS IDs starting from the RS ID with the largest L1-RSRP value that are indicated for TCI-state activation basis. A 3-bit TNR field may be able to indicate up to a total of eight RSs. This option may be premised on the basis that the base station 108 will likely indicate the strongest RSs for TCI state activation. As compared to the first option, the second option may lose some flexibility in the RSs that may be indicated, but it also saves overhead as it only needs three bits as compared to eight bits for indicating up to eight RSs.

Given that each RS ID may be a six-bit identifier, as shown in FIGS. 7 and 8, use of the indexing technique of the second aspect may significantly reduce signaling overhead.

The MAC CEs 900 may be identified by a MAC subheader with LCID and a fixed size depending on the value of N.

In some embodiments, a rule may be predefined in, for example, a 3GPP TS that indicates which of the RS(s) reported by the UE 104 are to be used to derive the TCI state(s). For example, in some instances, it may be predefined that the RS ID(s) with the largest L1-RSRP value(s) is (are) to be used for TCI state activation. In other examples, additional or alternative criteria may be predefined.

A third aspect of providing beam information may relate to providing SSB index(es) in the beam-indication message of FIG. 6. With this aspect, a PDCCH order may be used as the beam-indication message used to determine the activated TCI states for candidate cell. A PDCCH order may include a DCI format 1_0 transmission that instructs the UE 104 to trigger a random access procedure for uplink synchronization. The PDCCH order may be used to identify an SSB index for the uplink synchronization. Given a channel-reciprocity assumption, e.g., the uplink channel may be similar to the downlink channel, some embodiments may use this SSB index as a basis for also determining DL TCI states. The PDCCH order may be used for TCI state activation in accordance with one or more of the following options.

In a first option, the SSB indexes and corresponding candidate cell identifiers are explicitly indicated by a payload of the PDCCH order DCI. The SSB indexes may be used to determine the TCI states for activation operation and may be associated with one or more candidate cells to trigger a CFRA procedure for timing advance (TA) acquisition.

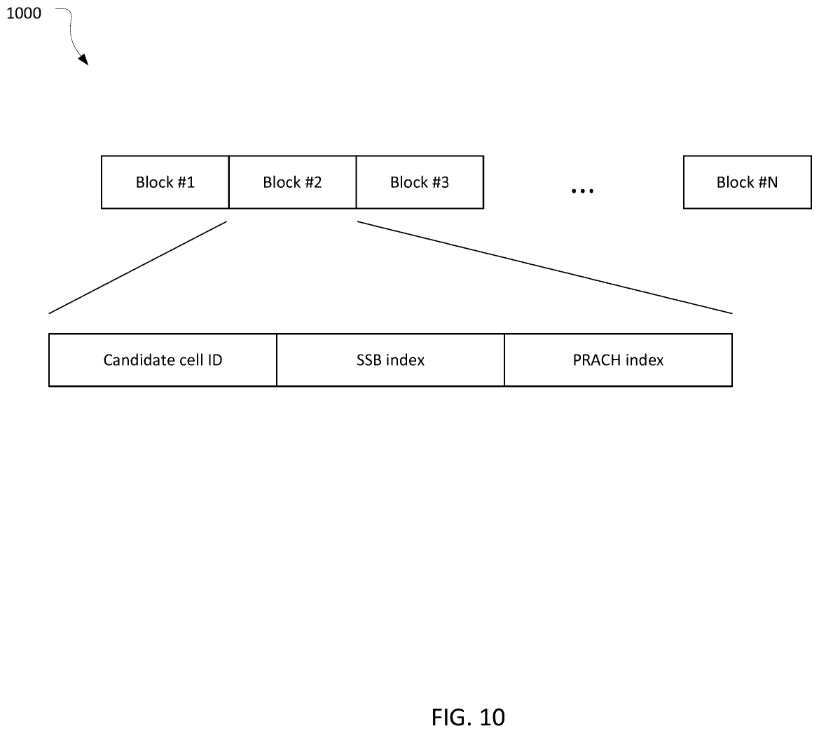

FIG. 10 illustrates a PDCCH order DCI 1000 in accordance with some embodiments. The PDCCH order DCI 1000 may have cyclic-redundancy check (CRC) bits scrambled by a new dedicated radio network temporary identifier (RNTI).

The PDCCH order DCI 1000 may include a plurality of blocks, block #1-block #N. The number of blocks may be configured by RRC signaling or fixed in a specification, for example, a 3GPP TS. Each block may include a field for candidate cell ID, SSB index, and PRACH index. The candidate cell ID may be a physical cell ID or a logical ID (e.g., an additionalPCIIndex value) that may be configured by RRC signaling.

The payload size of the PDCCH order DCI 1000 for LTM may be equal to or less than the payload size of a DCI format 1_0 monitored in a common search space of the same serving cell. If the payload size is less, zero padding may be used until the payload equals the DCI format 1_0 size.

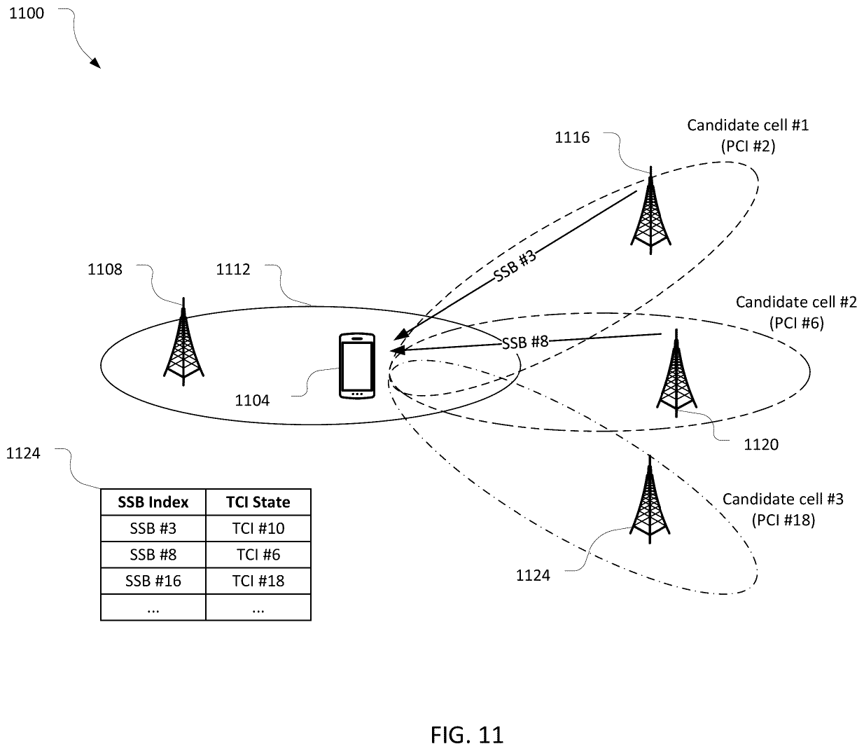

FIG. 11 illustrates a network environment 1100 to describe the third aspect in accordance with some embodiments.

The network environment 1100 may include a UE 1104, a base station 1108 providing a serving cell 1112, a base station 1116 providing a candidate cell #1 with a PCI #2, a base station 1120 providing a candidate cell #2 with a PCI #6, and a base station 1108 providing a candidate cell #3 with a PCI #18.The components of the network environment 1100 may be similar to those described above with respect to network environment 100.

The UE 1104 may receive SSB #3 from candidate cell #1 and SSB #8 from candidate cell #2.

The UE 1104 may receive a TCI state configuration 1124 that maps various SSB indexes to TCI states.

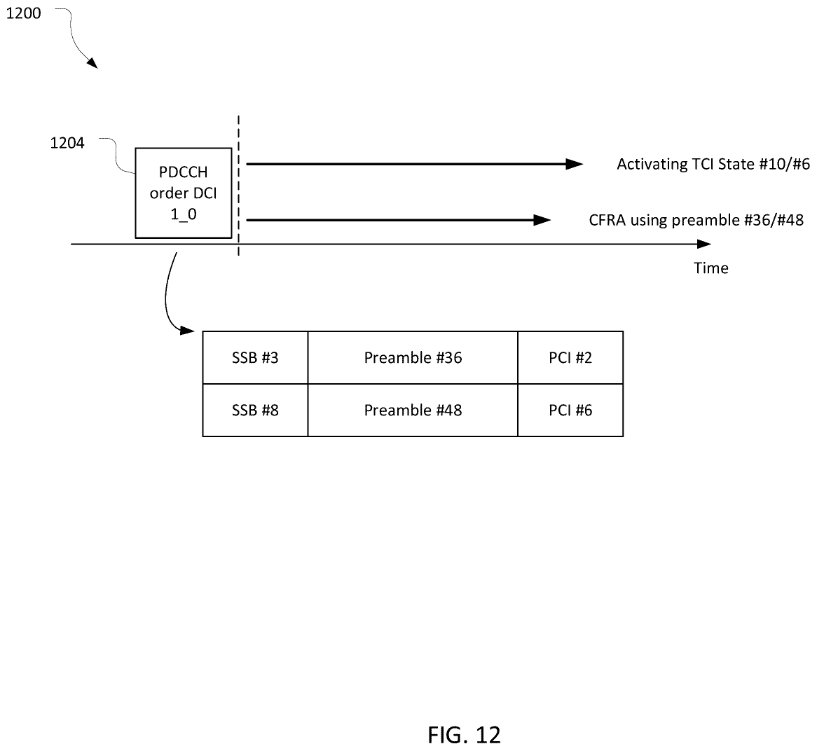

FIG. 12 illustrates a signaling diagram 1200 for activating TCI states in the network environment 1100 in accordance with some embodiments.

The signaling diagram 1200 may include a PDCCH order 1204 that configures the UE 1104 with a first block that includes SSB #3, preamble #36, and PCI #2 and a second block that includes SSB #8, preamble #48, and PCI #6. Thus, the first block may trigger CFRA toward candidate cell #1 (using preamble #36) and the second block may trigger CFRA toward candidate cell #2 (using preamble #48). The UE 104 may then assume, based on TCI state configuration 1124, that TCI state #10 is activated for candidate cell #1 for LTM operation and TCI state #6 is activated for candidate cell #2 for LTM operation.

In a second option of the third aspect, a two-step RS indication may be used. In the second option, instead of indicating the SSB/PRACH explicitly in the PDCCH order payload as done in the first option, a CFRA resource configuration is first provided through RRC signaling during an LTM pre-configuration phase and subsequently a PDCCH order is provided with indexes that reference the CFRA resource configuration.

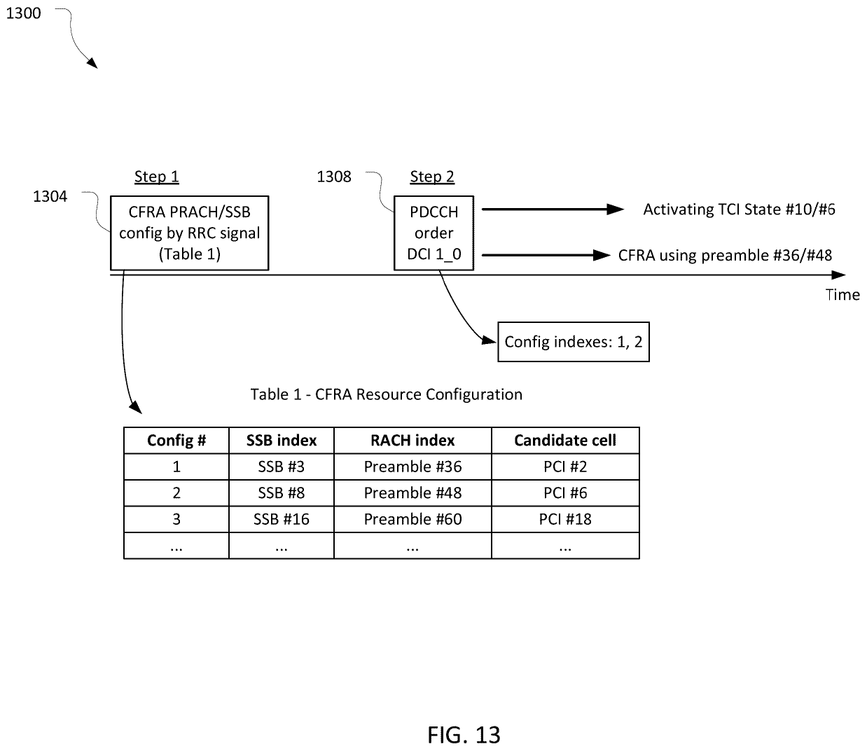

FIG. 13 illustrates a signaling diagram 1300 for activating TCI states in the network environment 1100 in accordance with some embodiments. In a first step, a CFRA resource configuration 1304 may be provided to the UE 104 by RRC signaling in an LTM pre-configuration phase. The CFRA resource configuration 1304 may configure CFRA preamble indexes (e.g., RACH indexes) with associated SSB indexes for each candidate cell.

In a second step, a PDCCH order 1308, including configuration indexes that refer to the CFRA resource configuration, may be transmitted to the UE 104. The UE 104 may obtain the configuration indexes from the PDCCH order 1308 and determine the activated TCI states in accordance with the SSB indexes associated with the indicated configuration indexes. As shown, the PDCCH order 1308 provides configuration indexes #1/#2. The UE 104 may then assume, based on TCI state configuration 1124 and CFRA resource configuration 1304, that TCI state #10 is activated for candidate cell #1 for LTM operation and TCI state #6 is activated for candidate cell #2 for LTM operation.

As compared to the first option, the second option may reduce signaling overhead of the PDCCH order. However, the second option may also have less flexibility compared to the first option given its reliance on the previously configured CFRA resource configuration 1304. In some embodiments, if the desired TCI state activation cannot be achieved through the second option, the UE 104 may fallback to using the first option described above with respect to FIG. 12.

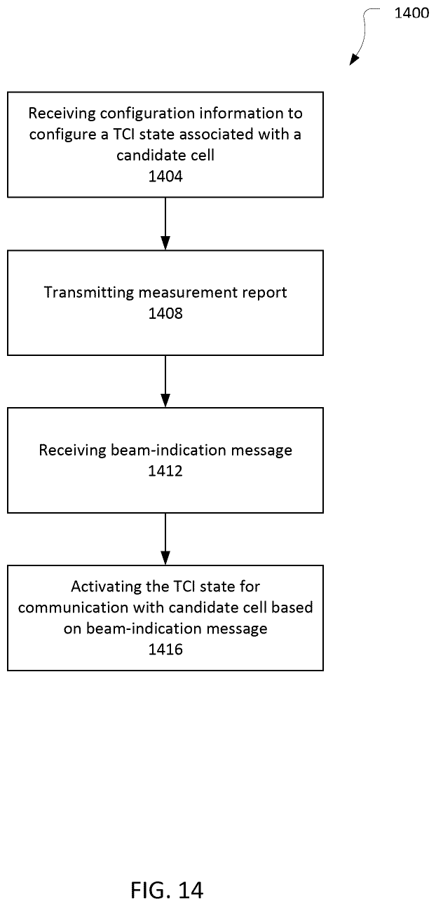

FIG. 14 illustrates an operational flow/algorithmic structure 1400 for beam configuration and indication for LTM operation in accordance with some embodiments. The operational flow/algorithmic structure 1400 may be implemented by a UE such as, for example, UE 104, UE 1104, UE 160 or components therein, for example, processors 1604.

The operational flow/algorithmic structure 1400 may include, at 1404, receiving configuration information to configure a TCI state associated with a candidate cell. In some embodiments, the configuration information may be a serving cell configuration that configures a TCI-state list with a plurality of TCI states including the TCI state. The configuration information may additionally associate the TCI states with corresponding additionalPCIIndex values. The additionalPCIIndex values may be associated with PCIs of various cells of a network environment. The association may be based on configuration information provided with or separate from the serving cell configuration.

In some embodiments, the configuration information may be a candidate cell configuration that configures a TCI-state list associated with the candidate cell or a common pool configuration that configures a TCI-state list for individual cells of a network environment. The candidate cell configuration or common-pool configuration may be separate from a serving cell configuration that configures a TCI-state list for the serving cell.

The operational flow/algorithmic structure 1400 may further include, at 1408, transmitting a measurement report. The measurement report may be based on measurements of reference signals transmitted by cells of a network environment. The reference signals may be SSB or CSI-RS signals. In some embodiments, the measurement report may include reference signal identifiers. In some embodiments, the reference signal identifiers may be ordered within the measurement report based on measurement values associated with the reference signals corresponding to the reference signal identifiers. For example, the measurement report may include a reference signal identifier associated with a highest reported measurement value first, and subsequent reference signal identifiers may be associated with decreasing measurement values.

The operational flow/algorithmic structure 1400 may further include, at 1408, receiving a beam-indication message. In some embodiments, the beam-indication message may indicate one or more TCI states associated with at least one candidate cell for activation. In other embodiments, the beam-indication message may include one or more reference signal identifiers and the UE may map the identifiers to TCI states for activation. In these embodiments, the beam-indication message may be a MAC CE that includes reference signal identifiers corresponding to one candidate cell, or a MAC CE that includes reference signal identifiers corresponding to a plurality of candidate cells. The MAC CE may include a MAC subheader with an eLCID to indicate the MAC CE is a TCI-state activation/deactivation MAC CE that includes reference signal identifiers.

In some embodiments, the beam-indication message may include reference signal indexes that may correspond to the reference signal identifiers of the measurement report. For example, the beam-indication message may include a bitmap with individual values corresponding to reference signal identifiers included in the measurement report. An individual bit value may indicate whether a corresponding reference signal identifier is to serve as a TCI-activation basis.

In some embodiments, the beam-indication message may indicate a total number of contiguous reference signal identifiers that are indicated for TCI-state activation basis starting with a reference signal identifier associated with a highest measurement value of the total number. In these embodiments, the measurement report may include the reference signal identifiers in decreasing order of associated measurement values. Thus, the total number signal may indicate one or more of the reference signal identifiers associated with the highest measurement values.

In some embodiments, the beam-indication message may be a PDCCH order for uplink synchronization. The PDCCH order may include one or more blocks, with each block having an identifier of a candidate cell (e.g., a PCI or logical identifier), an SSB index, and a PRACH index. The SSB index may serve as a TCI-state activation basis in these embodiments.

In some embodiments, an RRC signal may be used to configure a table that associates CFRA preambles and SSB indexes with candidate cells. Thereafter, a PDCCH order, used as the beam-indication message, may simply include an index to the configured table to indicate an SSB index that is to serve as a TCI-state activation basis.

The operational flow/algorithmic structure 1400 may further include, at 1408, activating the TCI state for communication with the candidate cell based on the beam-indication message.

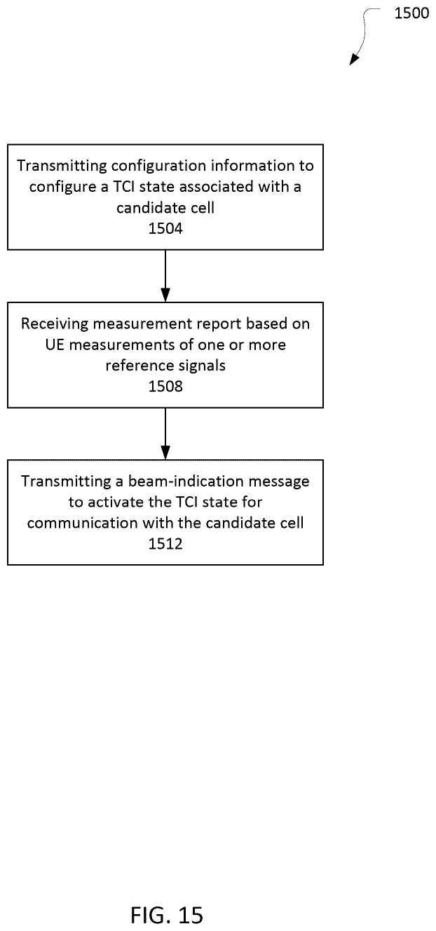

FIG. 15 illustrates an operational flow/algorithmic structure 1500 for beam configuration and indication for LTM operation in accordance with some embodiments. The operational flow/algorithmic structure 1500 may be implemented by a base station such as, for example, BS 108, BS 1108, or BS 1700 or components therein, for example, processors 1704.

The operational flow/algorithmic structure 1500 may include, at 1504, transmitting configuration information to configure a TCI state associated with a candidate cell. The configuration information may be similar to that described above with respect to FIG. 14.

The operational flow/algorithmic structure 1500 may further include, at 1508, receiving measurement report based on UE measurements of one or more reference signals. The measurement report may be similar to that described above with respect to FIG. 14.

The operational flow/algorithmic structure 1500 may further include, at 1512, transmitting a beam-indication message to activate the TCI state for communication with the candidate cell. The beam-indication message may be similar to that described above with respect to FIG. 14.

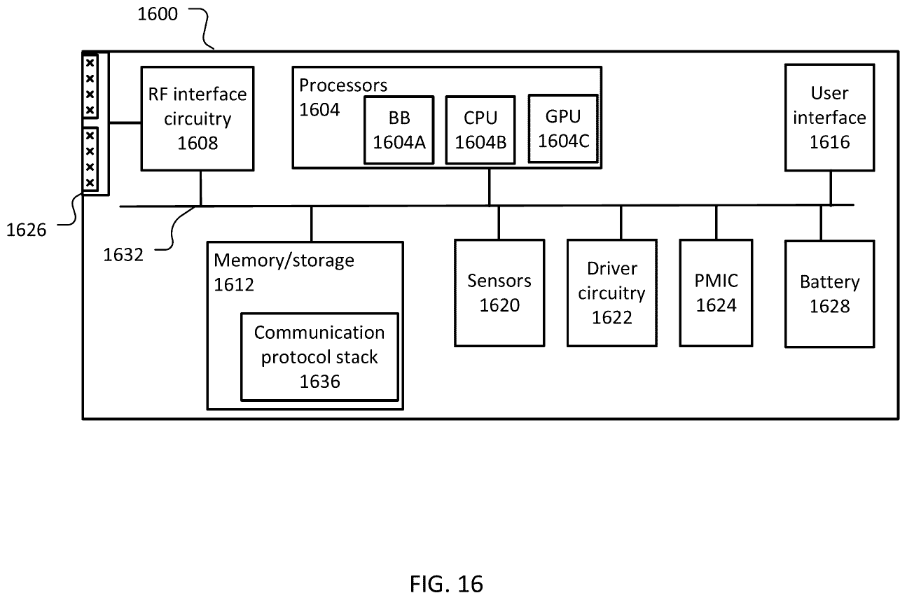

FIG. 16 illustrates a UE 1600 in accordance with some embodiments. The UE 1600 may be similar to and substantially interchangeable with UE 104 of FIG. 1 or UE 1104 of FIG. 11.

The UE 1600 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 1600 may include processors 1604, RF interface circuitry 1608, memory/storage 1612, user interface 1616, sensors 1620, driver circuitry 1622, power management integrated circuit (PMIC) 1624, antenna structure 1626, and battery 1628. The components of the UE 1600 may be implemented as integrated circuits (ICs), portions thereof, discrete electronic devices, or other modules, logic, hardware, software, firmware, or a combination thereof. The block diagram of FIG. 16 is intended to show a high-level view of some of the components of the UE 1600. However, some of the components shown may be omitted, additional components may be present, and different arrangement of the components shown may occur in other implementations.

The components of the UE 1600 may be coupled with various other components over one or more interconnects 1632, which may represent any type of interface, input/output, bus (local, system, or expansion), transmission line, trace, or optical connection that allows various circuit components (on common or different chips or chipsets) to interact with one another.

The processors 1604 may include processor circuitry such as, for example, baseband processor circuitry (BB) 1604A, central processor unit circuitry (CPU) 1604B, and graphics processor unit circuitry (GPU) 1604C. The processors 1604 may include any type of circuitry or processor circuitry that executes or otherwise operates computer-executable instructions, such as program code, software modules, or functional processes from memory/storage 1612 to cause the UE 1600 to perform beam configuration and indication operations for LTM as described herein.

In some embodiments, the baseband processor circuitry 1604A may access a communication protocol stack 1636 in the memory/storage 1612 to communicate over a 3GPP compatible network. In general, the baseband processor circuitry 1604A may access the communication protocol stack 1636 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1608.

The baseband processor circuitry 1604A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1612 may include one or more non-transitory, computer-readable media that includes instructions (for example, communication protocol stack 1636) that may be executed by one or more of the processors 1604 to cause the UE 1600 to perform beam configuration and indication operations for LTM as described herein. For example, the processors 1604 may cause the UE to perform the operational flow/algorithmic structure 1400, or any other method or process described herein.

The memory/storage 1612 include any type of volatile or non-volatile memory that may be distributed throughout the UE 1600. In some embodiments, some of the memory/storage 1612 may be located on the processors 1604 themselves (for example, L1 and L2 cache), while other memory/storage 1612 is external to the processors 1604 but accessible thereto via a memory interface. The memory/storage 1612 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1608 may include transceiver circuitry and radio frequency front module (RFEM) that allows the UE 1600 to communicate with other devices over a radio access network. The RF interface circuitry 1608 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1626 and proceed to filter and amplify (with a low-noise amplifier) the signal. The signal may be provided to a receiver of the transceiver that down-converts the RF signal into a baseband signal that is provided to the baseband processor of the processors 1604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1626.

In various embodiments, the RF interface circuitry 1608 may be configured to transmit/receive signals in a manner compatible with NR access technologies.

The antenna structure 1626 may include antenna elements to convert electrical signals into radio waves to travel through the air and to convert received radio waves into electrical signals. The antenna elements may be arranged into one or more antenna panels. The antenna structure 1626 may have antenna panels that are omnidirectional, directional, or a combination thereof to enable beamforming and multiple input, multiple output communications. The antenna structure 1626 may include microstrip antennas, printed antennas fabricated on the surface of one or more printed circuit boards, patch antennas, or phased array antennas. The antenna structure 1626 may have one or more panels designed for specific frequency bands including bands in FR1 or FR2.

The user interface 1616 includes various input/output (I/O) devices designed to enable user interaction with the UE 1600. The user interface 1616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1600.

The sensors 1620 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1622 may include software and hardware elements that operate to control particular devices that are embedded in the UE 1600, attached to the UE 1600, or otherwise communicatively coupled with the UE 1600. The driver circuitry 1622 may include individual drivers allowing other components to interact with or control various I/O devices that may be present within, or connected to, the UE 1600. For example, the driver circuitry 1622 may include circuitry to facilitate coupling of a UICC (for example, UICC 168) to the UE 1600. For additional examples, driver circuitry 1622 may include a display driver to control and allow access to a display device, a touchscreen driver to control and allow access to a touchscreen interface, sensor drivers to obtain sensor readings of sensors 1620 and control and allow access to sensors 1620, drivers to obtain actuator positions of electro-mechanic components or control and allow access to the electro-mechanic components, a camera driver to control and allow access to an embedded image capture device, audio drivers to control and allow access to one or more audio devices.

The PMIC 1624 may manage power provided to various components of the UE 1600. In particular, with respect to the processors 1604, the PMIC 1624 may control power-source selection, voltage scaling, battery charging, or DC-to-DC conversion.

In some embodiments, the PMIC 1624 may control, or otherwise be part of, various power saving mechanisms of the UE 1600 including DRX as discussed herein.

A battery 1628 may power the UE 1600, although in some examples the UE 1600 may be mounted deployed in a fixed location, and may have a power supply coupled to an electrical grid. The battery 1628 may be a lithium ion battery, a metal-air battery, such as a zinc-air battery, an aluminum-air battery, a lithium-air battery, and the like. In some implementations, such as in vehicle-based applications, the battery 1628 may be a typical lead-acid automotive battery.

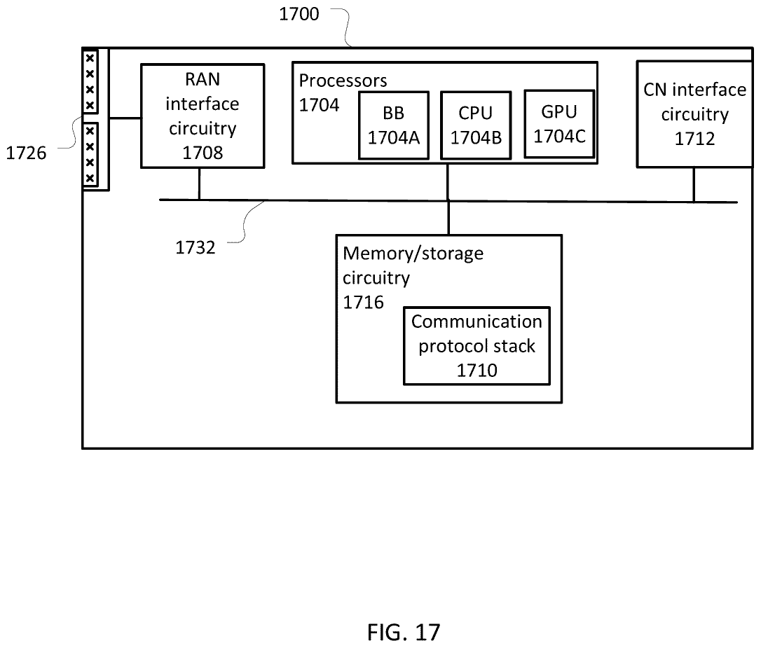

FIG. 17 illustrates a base station 1700 in accordance with some embodiments. The base station 1700 may be similar to and substantially interchangeable with base station 108 of FIG. 1 or base station 1108 of FIG. 11.

The base station 1700 may include processors 1704, RF interface circuitry 1708 (if implemented as an access node), core network (CN) interface circuitry 1712, memory/storage 1716, and antenna structure 1726.

The components of the base station 1700 may be coupled with various other components over one or more interconnects 1732.

The processors 1704, RF interface circuitry 1708, memory/storage 1716 (including communication protocol stack 1710), antenna structure 1726, and interconnects 1732 may be similar to like-named elements shown and described with respect to FIG. 16.

The memory/storage 1716 may include one or more non-transitory, computer-readable media that includes instructions (for example, communication protocol stack 1710) that may be executed by one or more of the processors 1704 to cause the base station 1700 to perform beam configuration and indication operations for LTM as described herein. For example, the processors 1704 may cause the base station 1700 to perform operational flow/algorithmic structure 1500, or any other method or process described herein.

The CN interface circuitry 1712 may provide connectivity to a core network, for example, a 5th Generation Core network (5GC) using a 5GC-compatible network interface protocol such as carrier Ethernet protocols, or some other suitable protocol. Network connectivity may be provided to/from the base station 1700 via a fiber optic or wireless backhaul. The CN interface circuitry 1712 may include one or more dedicated processors or FPGAs to communicate using one or more of the aforementioned protocols. In some implementations, the CN interface circuitry 1712 may include multiple controllers to provide connectivity to other networks using the same or different protocols.

In some embodiments, the base station 1700 may be coupled with transmit receive points (TRPs) using the antenna structure 1726, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary aspects are provided.

Example 1 includes a method of operating a user equipment (UE), the method comprising: receiving, from a serving cell, configuration information to configure a transmission configuration indicator (TCI) state associated with a candidate cell; transmitting, to the serving cell, a measurement report based on measurements of one or more reference signals; receiving, from the serving cell, a beam-indication message; and activating the TCI state for communication with the candidate cell based on the beam indication message.

Example 2 includes the method of example 1 or some other example herein, wherein: the configuration information is a serving cell configuration that: configures a TCI state list that includes the TCI state; and associates the TCI state with an additional physical cell identifier (PCI) index associated with a PCI of the candidate cell.

Example 3 includes the method of example 1 or some other example herein, further comprising: receiving, from the serving cell, a serving cell configuration that is to configure a first TCI-state list associated with the serving cell; and receiving, from the serving cell, a candidate cell configuration that includes the configuration information, wherein the configuration information is to configure a second TCI-state list associated with the candidate cell, wherein the second TCI-state list includes the TCI state.

Example 4 includes a method of example 1 or some other example herein, further comprising: receiving, from the serving cell, a common pool configuration that includes the configuration information, wherein the configuration information is to configure a first TCI-state list associated with the serving cell and a second TCI-state list associated with the candidate cell, wherein the second TCI-state list includes the TCI state.

Example 5 includes a method of example 4 some other example herein, further comprising: receiving a serving cell configuration and a candidate cell configuration, wherein the serving cell configuration and the candidate cell configuration are independent from the common pool configuration.

Example 6 includes a method of example 1 or some other example herein, wherein the beam-indication message is to indicate one or more TCI states associated with at least one candidate cell for activation, wherein the at least one candidate cell includes the candidate cell and the one or more TCI states includes the TCI state.

Example 7 includes a method of example 1 or some other example herein, wherein the beam-indication message is to indicate one or more reference signal identifiers associated with at least one candidate cell, wherein the at least one candidate cell includes the candidate cell and the method further comprises: mapping a first reference signal identifier of the one or more reference signal indexes to the TCI state; and activating the TCI state based on said mapping.

Example 8 includes a method of example 7 or some other example herein, wherein the beam-indication message comprises a TCI-state activation/deactivation media access control (MAC) control element (CE) with a single candidate cell identifier, associated with the candidate cell, and the one or more reference signal identifiers, wherein the one or more reference signal identifiers are all associated with the single candidate cell identifier.

Example 9 includes a method of example 7 or some other example herein, wherein the candidate cell is a first candidate cell, the at least one candidate cell includes the first candidate cell and a second candidate cell, the one or more reference signal identifiers includes the first reference signal identifier and a second reference signal identifier, and the beam-indication message comprises a TCI-state activation/deactivation media access control (MAC) control element (CE) with: a first candidate cell identifier associated with the first candidate cell; a second candidate cell identifier associated with the second candidate cell; the first reference signal identifier associated with the first candidate cell; and the second reference signal identifier associated with the second candidate cell.

Example 10 includes a method of example 8, example 9, or some other example herein, wherein the TCI-state activation/deactivation MAC CE comprises a MAC subheader with an extended logical channel identifier (eLCID) to indicate the TCI-state activation/deactivation MAC CE includes reference signal identifiers corresponding to one or more candidate cells.

Example 11 includes the method of example 1 or some other example herein, further comprising: receiving, in radio resource control (RRC) signaling, an indication of a total number of reference signals that can serve as a measurement-report basis; ensuring the one or more reference signals do not exceed the total number of reference signals; and generating the measurement report to include one or more reference signal identifiers that respectively correspond to the one or more reference signals, wherein the beam indication message includes a bitmap of one or more bits that respectively correspond to the one or more reference signal identifiers and a first bit value is to indicate a corresponding reference signal identifier is indicated for a TCI-state activation basis.

Example 12 includes a method of example 1 or some other example herein, wherein the one or more reference signals includes a plurality of reference signals, each of the plurality of reference signals having a corresponding measurement value, and the method further comprises: generating the measurement report to include a plurality of reference signal identifiers respectively associated with the plurality of reference signals, wherein the plurality of reference signal identifiers are ordered within the measurement report based on a decreasing order of measurement values of the associated reference signals; and wherein the beam indication message includes an indication of a total number of contiguous reference signal identifiers that are indicated for TCI-state activation basis starting with a reference signal identifier associated with a highest measurement value of the total number of contiguous reference signal identifiers.

Example 13 includes a method of example 1 or some other example herein, wherein the beam-indication message comprises a physical downlink control channel (PDCCH) order for uplink synchronization, the PDCCH order to include an identifier associated with the candidate cell, a synchronization signal block (SSB) index, and a physical random access channel (PRACH) index, and the method further comprises: determining the TCI state based on the SSB index.

Example 14 includes a method of example 13 or some other example herein, wherein the candidate cell is a first candidate cell, the PDCCH order includes a first block for the identifier, SSB index, and PRACH index associated with the first candidate cell, and the PDCCH order further includes a second block for an identifier, SSB index, and PRACH index associated with a second candidate cell.

Example 15 includes the method of example 1 or some other example herein, further comprising: receiving a radio resource control (RRC) signal to provide a first configuration that associates a contention free random access (CFRA) preamble and a synchronization signal block (SSB) index with the candidate cell, wherein the beam-indication message comprises a physical downlink control channel (PDCCH) order for uplink synchronization, the PDCCH order to include an index corresponding to the first configuration; and determining the TCI state based on the SSB index of the first configuration.

Example 16 includes a method to be implemented by a base station, the method comprising: transmitting, to a user equipment (UE), configuration information to configure a transmission configuration indicator (TCI) state associated with a candidate cell; receiving, from the UE, a measurement report based on measurements of one or more reference signals; and transmitting, to the UE, a beam-indication message to activate the TCI state for communication with the candidate cell.

Example 17 includes the method of example 16 or some other example herein, wherein: the configuration information is a serving cell configuration that: configures a TCI state list that includes the TCI state; and associates the TCI state with an additional physical cell identifier (PCI) index associated with a PCI of the candidate cell.

Example 18 includes the method of example 16 or some other example herein, further comprising: transmitting, to the UE, a serving cell configuration that is to configure a first list of one or more TCI states associated with the serving cell; and transmitting, to the UE, a candidate cell configuration that includes the configuration information, wherein the configuration information is to configure a second TCI-state list associated with the candidate cell, wherein the second TCI-state list includes the TCI state.

Example 19 includes the method of example 16 or some other example herein, further comprising; transmitting, to the UE, a common pool configuration that includes the configuration information, wherein the configuration information is to configure a first TCI-state list associated with a serving cell and a second TCI-state list associated with the candidate cell, wherein the second TCI-state list includes the TCI state.

Example 20 includes a method of example 19 or some other example herein, further comprising: transmitting, to the UE, a serving cell configuration and a candidate cell configuration, wherein the serving cell configuration and the candidate cell configuration are independent from the common pool configuration.

Example 21 includes a method of example 16 or some other example herein, wherein the beam-indication message is to indicate one or more TCI states associated with at least one candidate cell for activation, wherein the at least one candidate cell includes the candidate cell and the one or more TCI states includes the TCI state.

Example 22 includes a method of example 16 or some other example herein, wherein the beam-indication message is to indicate one or more reference signal identifiers associated with at least one candidate cell, the at least one candidate cell includes the candidate cell.

Example 23 includes a method of example 22 or some other example herein, wherein the beam-indication message comprises a TCI-state activation/deactivation media access control (MAC) control element (CE) with a single candidate cell identifier, associated with the candidate cell, and the one or more reference signal identifiers, wherein the one or more identifiers are all associated with the single candidate cell identifier.

Example 24 includes a method of example 22 or some other example herein, wherein the candidate cell is a first candidate cell, the at least one candidate cell includes the first candidate cell and a second candidate cell, the one or more reference signal identifiers includes a first reference signal identifier and a second reference signal identifier, and the beam-indication message comprises a TCI-state activation/deactivation media access control (MAC) control element (CE) with: a first candidate cell identifier associated with the first candidate cell; a second candidate cell identifier associated with the second candidate cell; the first reference signal identifier associated with the first candidate cell; and the second reference signal identifier associated with the second candidate cell.

Example 25 includes a method of example 23, example 24, or some other example herein, wherein the TCI-state activation/deactivation MAC CE comprises a MAC subheader with an extended logical channel identifier (eLCID) to indicate the TCI-state activation/deactivation MAC CE includes reference signal identifiers corresponding to one or more candidate cells.

Example 26 includes a method of example 16 or some other example herein, further comprising: transmitting, to the UE, radio resource control (RRC) signaling that includes an indication of a total number of reference signals that can serve as a measurement-report basis, wherein: the measurement report includes one or more reference signal identifiers that respectively correspond to the one or more reference signals; and the beam indication message includes a bitmap of one or more bits that respectively correspond to the one or more reference signal identifiers and a first bit value is to indicate a corresponding reference signal identifier is indicated for a TCI-state activation basis.

Example 27 includes the method of example 16 or some other example herein, wherein: the one or more reference signals includes a plurality of reference signals; each of the plurality of reference signals having a corresponding measurement value; the measurement report includes a plurality of reference signal identifiers respectively associated with the plurality of reference signals; the plurality of reference signal identifiers are ordered within the measurement report based on a decreasing order of measurement values of the associated reference signals; and the beam indication message includes an indication of a total number of contiguous reference signal identifiers that are indicated for TCI-state activation basis.

Example 28 includes a method of example 16 or some other example herein, wherein the beam-indication message comprises a physical downlink control channel (PDCCH) order for uplink synchronization, the PDCCH order to include an identifier associated with the candidate cell, a synchronization signal block (SSB) index, and a physical random access channel (PRACH) index, and the SSB index is to be used to activate the TCI state.

Example 29 includes the method of example 28 or some other example herein, wherein the candidate cell is a first candidate cell, the PDCCH order includes a first block for the identifier, SSB index, and PRACH index associated with the first candidate cell, and the PDCCH order further includes a second block for an identifier, SSB index, and PRACH index associated with a second candidate cell.

Example 30 includes a method of example 16 or some other example herein, further comprising: receiving a radio resource control (RRC) signal to provide a first configuration that associates a contention free random access (CFRA) preamble and a synchronization signal block (SSB) index with the candidate cell, wherein the beam-indication message comprises a physical downlink control channel (PDCCH) order for uplink synchronization, the PDCCH order to include an index corresponding to the first configuration; and determining the TCI state based on the SSB index of the first configuration.

Example 31 includes a method of operating a user equipment (UE), the method comprising: receiving, from a serving cell, configuration information to configure a transmission configuration indicator (TCI) state associated with a candidate cell; transmitting, to the serving cell, a measurement report based on measurements of one or more reference signals; selecting a reference signal from the one or more reference signals based on a predefined rule; determining the reference signal is associated with the TCI state; and activating the TCI state for communication with the candidate cell based on said selecting the reference signal and determining the reference signal is associated with the TCI state.

Example 32 includes a method of example 31 or some other example herein, wherein selecting the reference signal based on the predefined rule comprises: selecting the reference signal associated with a highest layer 1-reference signal receive power (L1-RSRP) value of the one or more reference signals.

Another example may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Another example may include an apparatus comprising logic, modules, or circuitry to perform one or more elements of a method described in or related to any of examples 1-32, or any other method or process described herein.

Another example may include a method, technique, or process as described in or related to any of examples 1-32, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-32, or portions thereof.

Another example include a signal as described in or related to any of examples 1-32, or portions or parts thereof.

Another example may include a datagram, information element, packet, frame, segment, PDU, or message as described in or related to any of examples 1-32, or portions or parts thereof, or otherwise described in the present disclosure.

Another example may include a signal encoded with data as described in or related to any of examples 1-32, or portions or parts thereof, or otherwise described in the present disclosure.

Another example may include a signal encoded with a datagram, IE, packet, frame, segment, PDU, or message as described in or related to any of examples 1-32, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Another example may include a computer program comprising instructions, wherein execution of the program by a processing element is to cause the processing element to carry out the method, techniques, or process as described in or related to any of examples 1-32, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing configuration information received from a serving cell, the configuration information to configure a transmission configuration indicator (TCI) state associated with a candidate cell;
generating, based on measurements of one or more reference signals, a measurement report to be transmitted to the serving cell;
processing a beam-indication message received from the serving cell; and
activating the TCI state for communication with the candidate cell based on the beam indication message.

2. The method of claim 1, wherein: the configuration information is a serving cell configuration that: configures a TCI-state list that includes the TCI state; and associates the TCI state with an additional physical cell identifier (PCI) index associated with a PCI of the candidate cell.

3. The method of claim 1, further comprising:
processing a serving cell configuration that is to configure a first TCI-state list associated with the serving cell; and
processing a candidate cell configuration that includes the configuration information, wherein the configuration information is to configure a second TCI-state list associated with the candidate cell, wherein the second TCI-state list includes the TCI state.

4. The method of claim 1, further comprising:
processing a common pool configuration that includes the configuration information, wherein the configuration information is to configure a first TCI-state list associated with the serving cell and a second TCI-state list associated with the candidate cell, wherein the second TCI-state list includes the TCI state.

5. The method of claim 4, further comprising:
processing a serving cell configuration and a candidate cell configuration, wherein the serving cell configuration and the candidate cell configuration are independent from the common pool configuration.

6. The method of claim 1, wherein the beam-indication message is to indicate one or more TCI states associated with at least one candidate cell for activation, wherein the at least one candidate cell includes the candidate cell and the one or more TCI states includes the TCI state.

7. The method of claim 1, wherein the beam-indication message is to indicate one or more reference signal identifiers associated with at least one candidate cell, wherein the at least one candidate cell includes the candidate cell and the method further comprises:
mapping a first reference signal identifier of the one or more reference signal indexes to the TCI state; and
activating the TCI state based on said mapping.

8. The method of claim 1, further comprising:
processing an indication, received in radio resource control (RRC) signaling, of a total number of reference signals that can serve as a measurement-report basis;
ensuring the one or more reference signals do not exceed the total number of reference signals; and
generating the measurement report to include one or more reference signal identifiers that respectively correspond to the one or more reference signals,
wherein the beam indication message includes a bitmap of one or more bits that respectively correspond to the one or more reference signal identifiers and a first bit value is to indicate a corresponding reference signal identifier is indicated for a TCI-state activation basis.

9. The method of claim 1, wherein the one or more reference signals includes a plurality of reference signals, each of the plurality of reference signals having a corresponding measurement value, and the method further comprises:
generating the measurement report to include a plurality of reference signal identifiers respectively associated with the plurality of reference signals, wherein the plurality of reference signal identifiers are ordered within the measurement report based on a decreasing order of measurement values of the associated reference signals; and
wherein the beam indication message includes an indication of a total number of contiguous reference signal identifiers that are indicated for TCI-state activation basis starting with a reference signal identifier associated with a highest measurement value of the total number of contiguous reference signal identifiers.

10. The method of claim 1, wherein the beam-indication message comprises a physical downlink control channel (PDCCH) order for uplink synchronization, the PDCCH order to include an identifier associated with the candidate cell, a synchronization signal block (SSB) index, and a physical random access channel (PRACH) index, and the method further comprises:
determining the TCI state based on the SSB index.

11. The method of claim 1, further comprising:
processing a radio resource control (RRC) signal that provides a first configuration that associates a contention free random access (CFRA) preamble and a synchronization signal block (SSB) index with the candidate cell, wherein the beam-indication message comprises a physical downlink control channel (PDCCH) order for uplink synchronization, the PDCCH order to include an index corresponding to the first configuration; and
determining the TCI state based on the SSB index of the first configuration.

12. One or more non-transitory, computer-readable media having instructions that, when executed, cause processing circuitry to:
generate configuration information to be transmitted to a user equipment (UE), the configuration information to configure a transmission configuration indicator (TCI) state associated with a candidate cell;
process a measurement report received from the UE, the measurement report based on measurements of one or more reference signals; and
generate a beam-indication message to be transmitted to the UE to activate the TCI state for communication with the candidate cell.

13. The one or more non-transitory, computer-readable media of claim 12, wherein: the configuration information is a serving cell configuration that: configures a TCI state list that includes the TCI state; and associates the TCI state with an additional physical cell identifier (PCI) index associated with a PCI of the candidate cell.

14. The one or non-transitory, computer-readable media of claim 12, wherein the instructions, when executed, further cause the processing circuitry to:
generate a serving cell configuration that is to be transmitted to the UE to configure a first list of one or more TCI states associated with the serving cell; and
generate a candidate cell configuration that includes the configuration information, wherein the configuration information is to configure a second TCI-state list associated with the candidate cell, wherein the second TCI-state list includes the TCI state.

15. The one or non-transitory, computer-readable media of claim 12, wherein the instructions, when executed, further cause the processing circuitry to:
generate a common pool configuration that includes the configuration information, wherein the configuration information is to configure a first TCI-state list associated with a serving cell and a second TCI-state list associated with the candidate cell, wherein the second TCI-state list includes the TCI state.

16. The one or non-transitory, computer-readable media of claim 12, wherein the beam-indication message is to indicate one or more TCI states associated with at least one candidate cell for activation, wherein the at least one candidate cell includes the candidate cell and the one or more TCI states includes the TCI state.

17. The one or non-transitory, computer-readable media of claim 12, wherein the beam-indication message is to indicate one or more reference signal identifiers associated with at least one candidate cell, the at least one candidate cell includes the candidate cell.

18. The one or non-transitory, computer-readable media of claim 12, wherein the instructions, when executed, further cause the processing circuitry to:
generate radio resource control (RRC) signaling that includes an indication of a total number of reference signals that can serve as a measurement-report basis,
wherein:
the measurement report includes one or more reference signal identifiers that respectively correspond to the one or more reference signals; and
the beam indication message includes a bitmap of one or more bits that respectively correspond to the one or more reference signal identifiers and a first bit value is to indicate a corresponding reference signal identifier is indicated for a TCI-state activation basis.

19. A baseband processor comprising:
processing circuitry to:
process configuration information to configure a transmission configuration indicator (TCI) state associated with a candidate cell;
generate, for transmission to a serving cell, a measurement report based on measurements of one or more reference signals;
select a reference signal from the one or more reference signals based on a predefined rule;
determine the reference signal is associated with the TCI state; and
activate the TCI state for communication with the candidate cell based on said selecting the reference signal and determining the reference signal is associated with the TCI state; and
interface circuitry coupled with the processing circuitry, the interface circuitry to communicatively couple the processing circuitry with a component of a device.

20. The baseband processor of claim 19, wherein to select the reference signal based on the predefined rule the processing circuitry is to:
select the reference signal associated with a highest layer 1-reference signal receive power (L1-RSRP) value of the one or more reference signals.
